(19) United States
(12) Patent Application Publication
(10) Pub. No.: US 2003/0101183 A1
(43) Pub. Date: May 29, 2003

(54) Information retrieval index allowing updating while in use

(76) Inventors: Navin Kabra, Pune (IN); Raghu Ramakrishnan, Madison, WI (US); Uri Shaft, San Leandro, CA (US)

Correspondence Address: QUARLES & BRADY LLP, 411 E. WISCONSIN AVENUE, SUITE 2040, MILWAUKEE, WI, 53202-4497, US

(21) Appl. No.: 09/994,138

(22) Filed: Nov. 26, 2001

(51) Int. Cl. G06F 17/30; G06F 7/00

(52) U.S. Cl. 707/8

(57) ABSTRACT

A reverse index useful for identifying documents in information retrieval searches may be used concurrently for indexing while it is updated with new documents. Interruption to the use of the index is kept to a manageable level by partitioning the index and updating only single partitions of the index at a given time and further by bifurcating the index into a high speed supplemental portion that may be corrected concurrently on a real-time basis and which is periodically merged with the larger main portion. These two structures are merged during reading after brief locking, with pointer redirection.

### CROSS-REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates to information retrieval using an index structure to identify data and, in particular, to an index that may be updated without noticeable interruption to users of the index.

A conventional information retrieval system allows users to find information in a collection of text documents. Each document is treated as a collection of keywords and a query of the collection of documents consists of finding all the documents that contain one or more of a given set of keywords. The results are usually returned in the order of relevance of the document to the particular query. For example, all the documents may be ranked according to how closely they match the given set of keywords or how many times the keywords are found in the document.

So that each document need not be reviewed at the time of each query, a reverse index may be constructed that lists each keyword linked to all the documents that contain the keyword. The user may provide a Boolean combination of keywords, for example, keywords connected by the connector “AND” or “OR”. The documents responsive to each keyword, as determined by the reverse index, are then merged according to the Boolean connectors. If the Boolean connector is an OR, the document sets are added together. If the Boolean connector is an AND, only the common documents of the two sets are returned. Complex expressions of Boolean connectors may be resolved by successive applications of these rules.

Over time, the document set may change, with new documents being added to the collection of documents and existing documents being deleted or changed. For new documents, the keywords are extracted from the documents and appropriate additions made to reverse index under existing keywords or if necessary under new keywords. Spaces may be left in the index to simplify this addition process, however, periodically a complete rewriting of the index will be necessary for efficient operation of the index. Changes and deletions may be accommodated by similar modification of the index.

For large indexes such as those used with Internet search engines, the rewriting process is sufficiently time consuming that it must be accomplished “offline”, that is, at a time when the index is not being used. For this reason, updating of the index is normally performed on a relatively infrequent basis. This infrequency can be tolerated because a typical Internet search is relatively imprecise and there is no expectation that every document relevant to the search is returned nor that the documents are current. In situations where the search must find current documents, for example in a legal document text search, the system is shut down on a regular basis, say in the evening, so that such updates may be performed.

Particularly for Internet related applications in which worldwide access from many time zones is a possibility, shutting down the database for updating is undesirable. Yet for new applications, users increasingly expect and need the document set to remain current.

### BRIEF SUMMARY OF THE INVENTION

The present inventors have developed a way of updating a reverse index while it is in use with minimum disruption to the users. The invention employs two components. First, the index is broken into small partitions. Second, a main portion of each partition is associated with a small rapidly accessible supplemental portion. Changes in the partitions over the short term are absorbed by supplemental portions. When these supplemental portions need to be merged with the main portions, only one partition of that index needs be disabled at a time. Through proper selection of partition size, the amount of time that each partition is disabled may be so short as to be virtually unnoticed by users awaiting the results of a query and accordingly the merger, and in fact the entire process, can be accomplished on-line. A change-log file, which prerecords changes written to the supplemental portions, guards against the possibility of loss of data from the supplemental portions, the latter which are normally based in volatile memory.

Specifically then, the present invention provides a method of updating a reverse index for information retrieval, the index linking a set of keywords to document identifiers. Keywords in the context of this application should be considered to include any searchable term. The method includes the step of dividing the index into a plurality of partitions. Keywords and document identifiers for a new document are received and matched to a partition. Periodically one partition is locked for updating with the document identifiers for the keywords matching the partition while the other partitions are kept unlocked for concurrent reading. After updating, the locked partition is unlocked, another partition locked, and this cycle repeated.

Thus it is one object of the invention decrease the time required to update a locked portion of the index that may be required for a query, and thereby to reduce disruption from the updating process to an acceptable level so as to make possible concurrent use of the index and updating of the index.

Received queries or portions of received queries are also matched to one partition and the partitions matching those portions read to respond to the query.

It is therefore another object of the invention to use partitioning to reduce the chance that a given query will require use of a locked portion of the index.

The same mechanism matching portions of the queries may be that which matches keywords to the partitions for updating, such as a hash table.

Thus, it is another object of the invention to provide a simple mechanism for partitioning both queries and the update process.

The keywords and document identifiers for the new document may be stored in a change-log file before updating the locked partition. The change-log file may include a time stamp indicating the time of storing the keywords and document identifiers for the new document and the partition may include a time stamp indicating when the partition was last updated. The step of updating the partitions may read entries from the change-log having a time stamp later than the time stamp of the partition.

Thus it is another object of the invention to provide a method of ensuring changes are stored in a redundant file in the event of data loss.

The partitions may include a main portion stored in a first storage device having a first access speed and a supplemental portion stored in a second storage device having a second access speed faster than the first access speed. The step of updating the index may update the supplemental portion of the locked partition and queries of the index may be directed to read both the main portion and the supplemental portion.

Thus, it is another object of the invention to make use of the partitioning to allow rapid short-term updating of the index on an arbitrarily short time interval using high speed but size-limited memory.

The main portion may be merged with the supplemental portion at predetermined intervals. The first storage device, for example, can be a disk drive and the second storage device, solid-state memory. The predetermined interval of merging may be selected from the group consisting of a periodic interval based on the amount of data stored in the supplemental portion, a constant periodic interval, and a periodic interval based on the partition.

Thus, it is another object of the invention to permit the adoption of a flexible merging scheme whose timing is independent on the desired currency of the index.

The merging may compact the combined supplemental portion and main portion and may compute global statistics of the combined supplemental portion and main portion.

Thus, it is additional objects of the invention to allow extremely compact storage of the index. The use of a supplemental portion and main portion and the partitioning eliminates the need to build in expansion room into the index itself. It is a further object of the invention to provide separate computation of global statistics of the index that is not necessarily tied to the frequency of updating the index.

The step of merging may include freezing the supplemental portion and designating a second supplemental portion for receiving new keywords and document identifiers for new documents. This may be followed by combining the frozen supplemental portion and the main portion to create a second main portion and deleting the frozen supplemental portion and the main portion and using the second supplemental portion as the supplemental portion and using the second main portion and the main portion.

Thus, it is another object of the invention to allow concurrent updating and merging to further reduce the time during which an individual partition is incapacitated.

Queries are directed to the frozen supplemental portion, the second supplemental portion and the main portion.

Thus, it is a further object of the invention to allow simultaneous updating, merging and querying of the locked partition.

The step of using the second supplemental portion as the supplemental portion, and the second main portion as the main portion may be accomplished by a simple redirecting of the pointers.

Thus, it is another object of the invention to provide for extremely fast substitution of files minimizing the user disruption.

The method may provide for the receiving of bulk-load keywords and document identifiers for the index and pre-dividing the bulk-load keywords and document identifiers into partitioned files related to the partitions of the main and supplemental portions of the index. The bulk load material may then be sequentially stored in a partitioned file in the second storage device and merged with corresponding partition of the main portion.

Thus it is another object of the invention to allow for large mounts of data to be quickly and efficiently loaded into the index using a specialized method for bulk loading data.

The foregoing objects and advantages may not apply to all embodiments of the inventions and are not intended to define the scope of the invention, for which purpose claims are provided. In the following description, reference is made to the accompanying drawings, which form a part hereof, and in which there is shown by way of illustration, a preferred embodiment of the invention. Such embodiment also does not define the scope of the invention and reference must be made therefore to the claims for this purpose.

### BRIEF DESCRIPTION OF THE DRAWINGS

FIG. 1 is a schematic representation of a prior art information retrieval system showing application of a query to a reverse index of keywords and document identifiers, the index being compiled from a document set ones of which may be identified by the index to produce a document list;

FIG. 2 is a figure similar to that of FIG. 1 showing the information retrieval system of the present invention in which the index is partitioned through the use of a hash table operating both on the queries and on updates and each partition is bifurcated into a supplemental and main portions;

FIG. 3 is a detailed view of the index of FIG. 2 showing the bifurcation of the partitions into supplemental and main portions and showing the storage of global and time stamp data;

FIGS. 4a-4c are a series of sequential views of simplified representations of the index of FIG. 3 prior to updating, during updating, and subsequent to updating, further showing concurrency of use of the index, updating of the index, and merging of the index as provided by the present invention;

FIG. 5 is a flow chart showing the steps of reading the index of the present invention;

FIG. 6 is a flow chart showing the steps of updating and merging the index per FIGS. 4a-4c;

FIG. 7 is a flow chart of the steps of recovering from an index failure;

FIG. 8 is a flow chart showing the steps of updating the supplement portions of the index;

FIG. 9 is a figure similar to that of FIGS. 4a through 4b but providing a relative scale between the supplemental portions and main portions of the index and showing inefficiency of the index process during the bulk-loading of records; and

FIG. 10 is a figure similar to that of FIG. 9 showing a prepartitioning of the records being bulk-loaded for more efficient integration with the index of the present invention.

### DETAILED DESCRIPTION OF THE PREFERRED EMBODIMENT

### General Structure of an Information Retrieval System

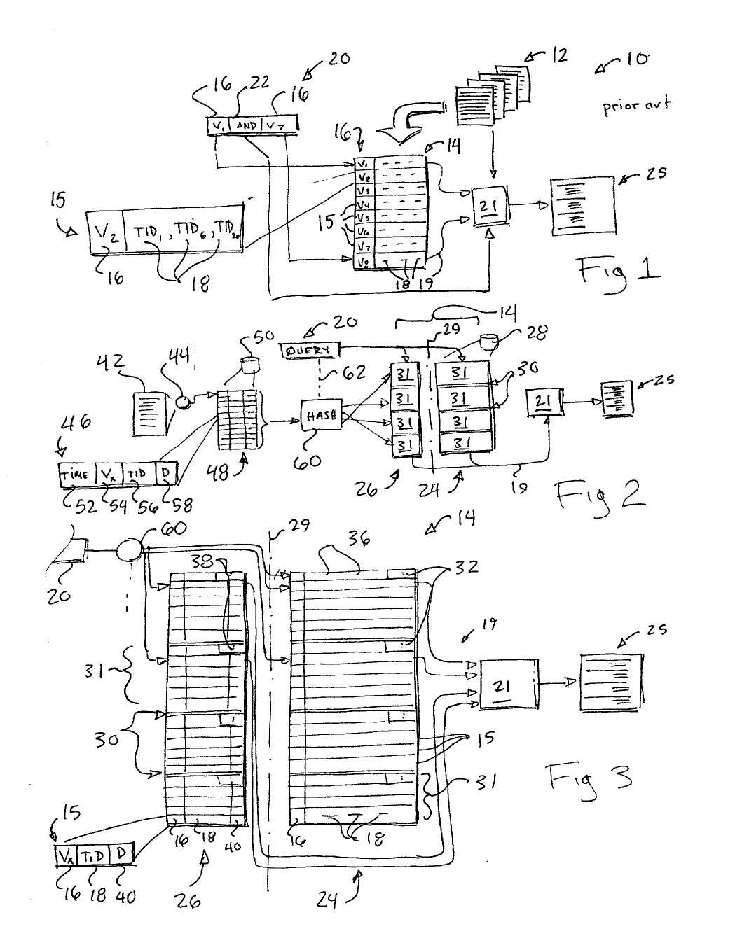

Referring now to FIG. 1, an information retrieval system 10 of a type known in the prior art provides access to a document set 12 of text documents as abstracted in a reverse index 14. Reverse index 14 provides a series of records 15, depicted as rows, and indexed by keywords 16 (shown generally as query values V₁ et seq.) that may be found in the document set 12. Each keyword 16 is linked to one or more document identifiers 18 (in which that keyword 16 is found) identifying a particular document of the document set 12. While the index 14 is shown as a table, it will be understood that this is a logical abstraction and that a number of other well-known structures may be used that are not strictly tables so long as they provide an index-like function.

A query 20 of the information retrieval system 10 may be formed from a Boolean combination of keywords 16 joined by one or more Boolean connectors 22, the latter being typically AND and OR, as may be supplemented with the Boolean prefix of NOT.

The query 20 is processed by matching the keywords 16 to corresponding records 15 of the reverse index 14 to produce multiple sets of document identifiers 18. The sets 19 are received by a combiner 21, which also receives the Boolean connectors 22 to produce a result list 25 indicating those documents meeting the query conditions. The combiner 21 may extract bibliographic data, such as document title, from the document set 12 based on the document identifiers 18. The documents of the document set 12 may also be accessed through the combiner 21 via the result list 25.

### Data Structures of the Present Invention

Referring now to FIG. 2, the present invention divides the prior art reverse index 14 of FIG. 1 into a main portion 24 and a supplemental portion 26, each of which contain records 15. Typically, the main portion 24 will be stored on a nonvolatile mass storage device such as a hard disk system 28, whereas the supplemental portion 26 will be implemented as solid-state memory. As is understood in the art, solid-state memory has much faster access times than the hard disk system 28 but is more costly and thus limited to smaller storage sizes. The division of the reverse index 14 into different memory types is indicated by boundary line 29. Generally, the supplemental portion is much smaller than the main portion.

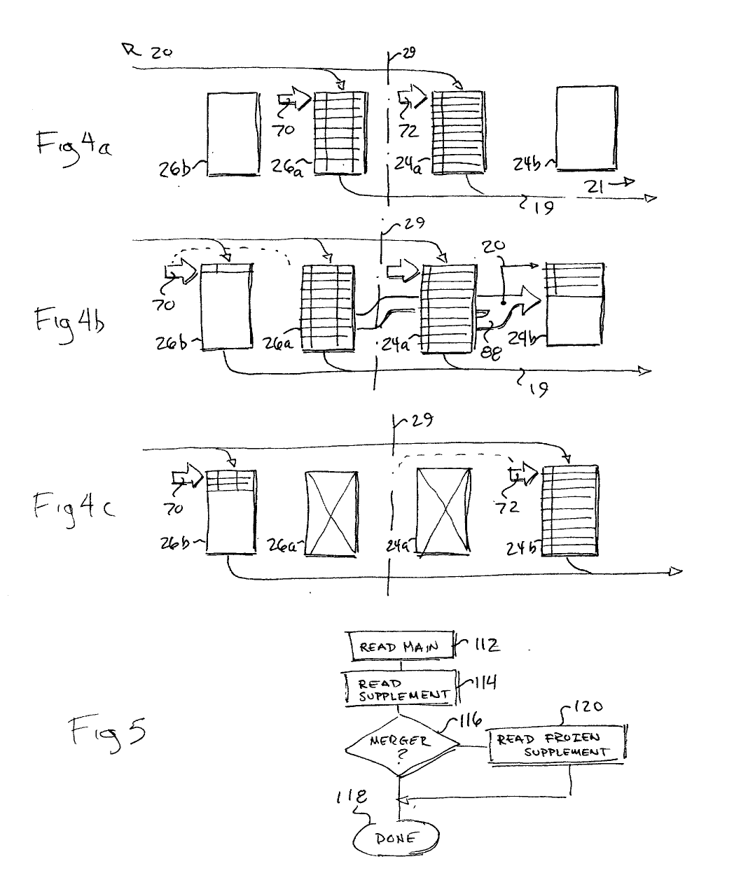

Referring also to FIG. 3, the reverse index 14 of the present invention, including its supplemental and main portions 26 and 24, is also partitioned with respect to records 15 as indicated by partition lines 30 cutting across the supplemental and main portions 26 and 24. The partitioning is also such that the records 15 of the supplemental portion 26 have keywords 16 within a common range of keywords 16 with the records 15 of the main portion 24 for a given partition 31. Each query 20 uses a hash table 60, as indicated by dotted line 62, to determine the particular partition 31 of the supplemental portion 26 and main portion 24 where its particular keywords 16 will be found. Other methods than a hash table 60 may also be used including, for example, a static mapping of contiguous alphabetic ranges of keywords to particular partitions 31.

The partitions 31 are sized so that the supplemental portions 26 may be atomically updated in extremely rapid fashion without interruption to the essential features of the index in the terms of reading or writing. As will be seen, the partitioned supplemental portions 26 thus allow for short term updating of the index formed by the supplemental portion 26 and main portion 24. The partitions 31 are also sized so that the probability of one or more query 20 needing multiple records 15 of the partition 31 at any given time is suitably low, to present relatively little interruption to use of the index 14 when the main portions 24 and supplemental portions 26 are merged as will be described below.

Continuing to refer to FIG. 3, a first record 15 in each partition 31 of both supplemental and main portions 26 and 24 includes a time stamp 38 and 32, respectively, as will be described below. The first record 15 in the main portion 24 also includes several global values 36 as will be described below.

Each record 15 of the main portion 24 and supplemental portions 26, after the first record of the partition 31, like the records of the prior art index 14, includes a keyword 16 linked to document identifiers 18, shown as separate columns. Each record 15 of the supplemental portion 26, after the first record of the partition 31 (shown in FIG. 3), also includes in a last column, a change code 40. The change code 40 provides a value indicating whether the record 15 of the supplemental portion 26 is for the purpose of deleting old data from the main portion 24 or adding new data to the main portion 24, as will be described further below.

Referring to FIG. 2, a change-log file 48 stores updates that need to be made in the index 14, (changes, additions, and deletions) such as are implemented in the form of a change document 42. If the change document 42 is a new document, then when it is submitted for indexing, its keywords 54 are extracted by a preprocessor 44 and inserted into a record 46 of a change-log file 48. The change-log file 48 may, but need not be stored on the same hard disk system 28 used for the main portion 24. Each record 46 of the change-log file 48 will include: a time stamp 52 as to when the document 42 was received and indexed by the preprocessor 44, a keyword 54 from the new document 42, at least one document identifier 56 identifying the new document 42, and a change code 58 (similar to change code 40) indicating that the document requires a deletion, or addition of existing data of the main portion 24. The change-log file 48 stores each record 46, in order of time stamp 52.

Generally, during an updating process, the records 46 of the change-log file 48 are presented to a hash table 60, which acting on the keywords 54 of the records 46 determines a particular partition 31 of the supplemental portion 26 into which the change will be placed. The hash table 60 thus sorts the records 46 according to keyword ranges associated with each partition 31.

### The Querying Process

Referring to FIGS. 2 and 3, a query 20 uses the hash table 60 to identify relevant records 15 both of the supplemental portion 26 and main portion 24 based on its keywords 16. The document identifiers 18 from each of the supplemental portion 26 and main portion 24 are then provided to the combiner 21, which first merges the document identifiers 18 from corresponding records 15 of the supplemental portion 26 and main portion 24. This first merger is according to the change code 40 of the records 15 of the supplemental portion 26 and (1) combines the document identifiers of the supplemental portion 26 and main portion 24 when the change code indicates an addition of a new document, and (2) deletes the common document identifiers of the supplemental portion 26 and main portion 24 when the change code indicates a deletion of a document. The combiner 21 then performs a second merger using the Boolean connectors of the query 20 to combine the resulting sets 19 as understood to those of ordinary skill in the art.

The present invention modifies this process slightly during a merging of the supplemental portions 26 and the main portions 24 as will be described below.

### The Updating Process

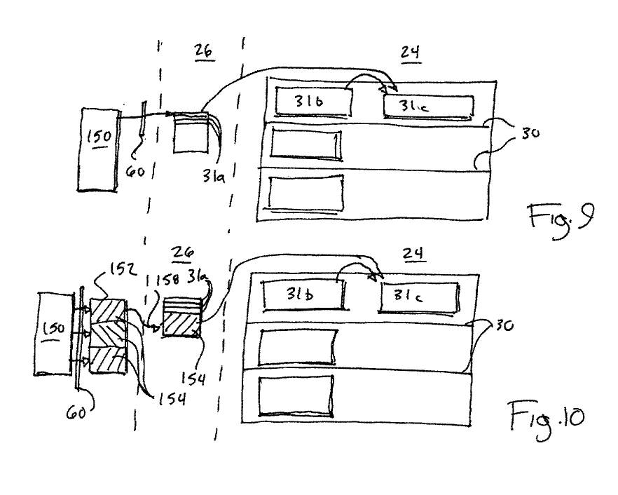

Referring to FIGS. 2 and 8, as changes are stored in the change-log file 48, these changes are moved to the supplemental portions 26 of the index 14. A program, executed by the index server holding the index 14, performs an update on a partition-by-partition basis as indicated by process block 66 of FIG. 8. The partitions 31 may be scanned on a regular interval in sequence or may be updated as required based on a review of the queued data of the change log file 48 or the arrival of new documents or it may be keyed to the particular partition 31 and an a priori knowledge about activity in those partitions. Normally, the program updates one partition 31 at a time to minimize the disruption to ongoing queries, although this is not necessary.

As indicated by process block 68, the partition 31 to be updated is first locked against reading, thereby blocking ongoing queries 20 from interfering with the updating process. At process block 71, the time stamp 38 of the supplemental portion 26 of the partition being updated is read. At process block 73, the change-log file 48 shown in FIG. 2 is reviewed from most recent entries to later entries and all those entries that have later time stamp 52 than the time stamp 38 and are of the locked partition. As each entry of the change-log file 48 is read, it is hashed with hash table 60 to see whether it belongs to the updating partition and, if not, it is ignored and the next entry is obtained. Only those entries hashing to the updating partition 31 selected at process block 66 are used. It will be understood that alternatively, the appropriate entries for the partition may be presorted by the hash table before locking of process block 68. The updating in this case contemplates insertion of new records 15 in sorted order according to keyword 16.

The selected entries from the change-log file 48 are transferred to the supplemental portion 26 of the updated partition. When the last entry per time order is read from the change-log file 48, a new time stamp 38 is written to the partition of the supplemental portion 26 as indicated by process block 74 and at process block 75, the supplemental portion 26 being updated is unlocked. Note that this updating process of FIG. 8 affects only the supplemental portions 26 and that because of the extremely rapid access to the memory device of the supplemental portions 26 and the small size of the partition 31, the time between the locking at process block 68 and the unlocking at process block 64 can be arbitrarily short.

### The Merging Process

As described above, the processing of queries 20 reads both the supplemental portion 26 and the main portion 24 and thus no further action would be required to update the index 14 other than this updating of the supplemental portion 26, except for the limitations on the size of the supplemental portion 26 which is implemented in high speed memory. Accordingly, the invention contemplates periodically merging supplemental portion 26 and the main portion 24 of the index 14 also in a manner to avoid significant disruption to ongoing queries.

The merging process may occur on a regular basis or based on known statistics about the partition 31 or may be triggered by the size of the supplemental portion 26 so that those supplemental portions 26 filling first are merged preferentially with the main portions 24.

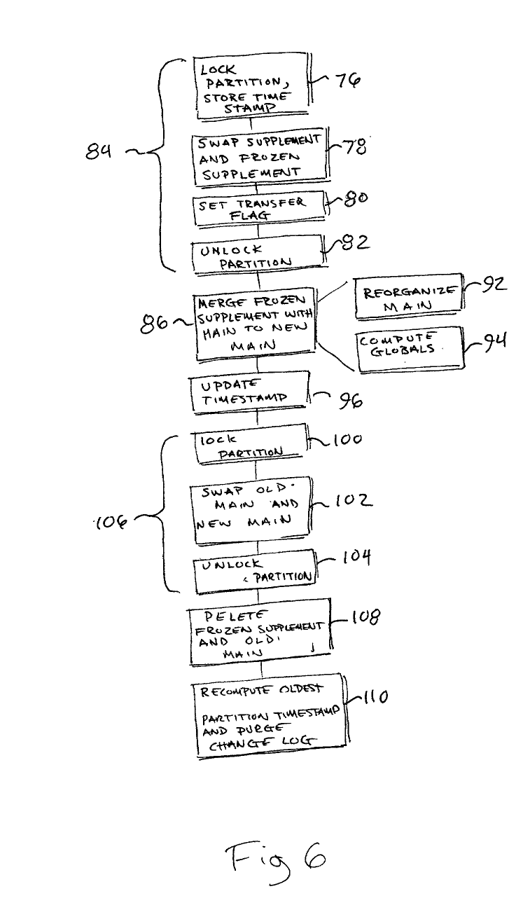

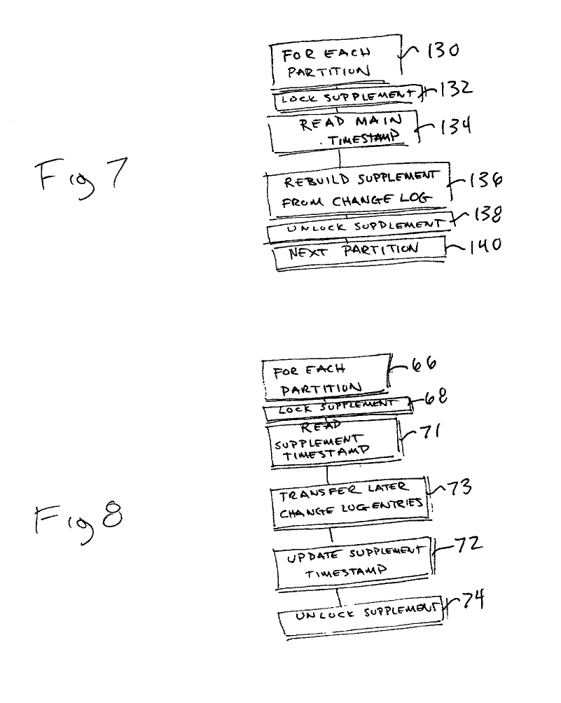

Referring now to FIGS. 6 and 4a, in order to accomplish this merging process, the invention allocates duplicate structures for the supplemental portion 26, here designated as supplemental portions 26a and 26b, and the main portion 24, here designated as main portions 24a and 24b. Pointers 70 and 72 point to the current supplemental portion 26a and the current main portion 24a. During normal operation of the reverse index 14, queries 20 are applied to the supplemental portions 26a and main portions 24a to produce document identifiers 18 and updates are applied to the supplemental portion 26a as described above.

The merging of the supplemental portion 26a and main portion 24a, necessary to avoid running out of room in the supplemental portion 26a as changes are processed, occurs on a partition-by-partition basis and begins at process block 76 with a locking against reading and writing of the supplemental portion 26a being updated. At this time, the time stamp 38 of that partition 31 is stored against the possibility of a crash during the merging process.

As illustrated by FIG. 4b, a pointer 70 used to identify the current supplemental portion 26 is then moved to point to the supplemental portion 26b swapping the supplemental portions 26a and 26b and freezing the supplemental portion 26a. Supplemental portion 25b will now receive updates.

At process block 80, a flag is set indicating that the queries 20 should now consider three structures, the secondary supplemental portion 26b, the frozen supplemental portion 26a, and the main portion 24a for that partition 31. There is a different flag for each partition 31 so that this additional review step is limited to the single locked partition 31.

At process block 82, the supplemental portion 26a is unlocked. The total time 84 during which the supplemental portion 26 is locked is extremely short because it requires only the movement of the pointer 70 and setting of a flag. Further, there need be no delay in accumulating updates into supplemental portion 26b after the pointer 70 is moved.

As indicated by process block 86, the data of supplemental portion 26a and main portion 24a next are merged into main portion 24b. Because the data in supplemental portion 26a and main portion 24a is not deleted at this time, but only copied as they are merged, the index 14 can continue to function in a read capacity. The lack of time constraint in the merger process indicated by arrow 88 allows the merger to include optimization per process block 92, for example, a sorting and compacting of the data. Because the size of supplemental portion 26a and main portion 24a (prior to merging) is known, no gaps need be placed in receiving structure of main portion 24b.

At this time as indicated by arrow 90, global statistics, for example, the total number of occurrences of keywords 16 or the total number of document identifiers 18 may be computed for use in relevance calculations of types known in the art. The computation of global values is indicated by process block 94. At the conclusion of this process, the time stamp for the new main portion 24b is updated with the time stamp saved from process block 76 per process block 96.

Referring now to FIGS. 4c and 6, the main portion 24a is next locked against reading and writing as indicated by process block 100 and as indicated by process block 102, index pointer 72 is moved to point to the new main portion 24b, which now becomes the structure interrogated by queries 20. The partition 31 is unlocked at process block 104 providing for extremely short disruption to use of the index 14 indicated by time 106 between process blocks 100 and 104 which embrace only the locking operations and a pointer swap.

At process block 108, the frozen supplemental portion 26a and main portion 24a are deleted and their memory locations free to be used in a repetition of this process where main portion 24b is merged to main portion 24a and supplemental portion 26b becomes supplemental portion 26a as depicted again in FIG. 4.

At process block 110, each of the partitions 31 is reviewed to compute the oldest time stamp for any of these partitions 31 and the change-log file 48 shown in FIG. 2 is updated to erase the entries to the point of the oldest time stamp. In this way the change-log file 48 is kept to a manageable size but always includes the necessary data to reconstruct all supplemental portions 26 held in volatile memory.

Referring now to FIG. 5, the general querying process of the index 14, described in part, may thus be fully understood beginning at process block 112 with a reading of the main portion 24 of the index followed at process block 114 with a reading of the supplemental part of the index and a determination at decision block 116 as to whether a merger is in progress as described above with respect to FIG. 4b. If there is no merger being performed, the reading complete, as indicated by process block 118. If there is a merger, however, the frozen supplemental portion 26a must be read as described above with respect to FIG. 4b as indicated by process block 120.

### Recovery from Data Loss

As was referred to earlier, the present invention also provides for a method of recovering from data loss of data temporarily stored in the supplemental portions 26 as are typically held in vulnerable, volatile memory.

Referring now to FIG. 7, in the event of such data loss in which one or more supplemental portions 26 are lost, each partition 31 is refreshed in sequence as indicated by process block 130. First, at process block 132, the supplemental portion 26 of the given partition 31 is locked. The index time stamp 32 of the corresponding main portion 24 is read at process block 134 typically being preserved because it was stored in nonvolatile memory. A process block 136, the supplemental portion 26 of that partition is rebuilt from the change-log file 48 relying on the time stamp 32 of the main portion 24.

At process 138, the supplemental portion 26 is unlocked and the next partition 31 is obtained at process block 140. In the event of such a data loss, the currency of the index 14 is temporarily degraded, however, it is quickly regained from the change-log file 48.

The interposition of the change-log file 48 between the change documents 42 and the index 14 ensures that all changes are captured in nonvolatile memory in the event of computer system failure that may erase the supplemental portions 26.

### Bulk-loading

Referring now to FIG. 9, a bulk-loading of the reverse index 14 with bulk index data 150 may be required in certain situations. Such situations arise during the initial generation of the index 14 (“seeding”) or during later additions of data that is not obtained on a continuous basis but received in batches of once a week or once a month. Bulk-loading may also be required during data recovery from a backup file that may be a week or a month old.

As depicted, often the bulk index data 150 will often be greater in size than the aggregate size of the partitions 31a of the supplemental portion 26. In such cases an inputting of the bulk index data 150 to the partitions 31 of the supplemental portion 26, using the hash table 60 described above, or the like, will fill the partitions 31a several times over, causing repeated mergers where the partitions 31a of the supplemental portion 26 are combined with corresponding partitions 31b of the main portions 24 as has been described above with respect to FIGS. 4a through 4c

To the extent that partitions 31a are much smaller than 31b, such a merger process is extremely inefficient requiring a rewriting of a large amount of data of partitions 31b simply to add a relatively small amount of data of partition 31a. When the bulk index data 150 is much larger than the partitions 31a, this inefficiency is exacerbated by a repeated filling and writing of this merging process.

Accordingly, as shown in FIG. 10, the present invention contemplates a bulk-loading process in which bulk index data 150 is pre-partitioned into separate temporary partition files 152 generally corresponding to the partitions 31a in range and number. The partitioning process that converts the bulk index data 150 into the partition files 152 may be effectively off-line and thus does not interfere with the use of index 14.

Each of the partitioned temporary files 154 will generally be small enough to fit individually within the supplemental portion 26 of main memory or can be sized to so fit by additional partitioning. As indicated by arrow 158, one partitioned temporary files 154 at a time is thus loaded into the supplemental portion 26, preferably not into a partition 31a so that the index may continue to function without interruption as has been described above.

Once this loading is complete, a similar technique to that used to merge partitions 31a and 31b is used to merge the partitioned temporary files 154 with partition 31b to form temporary file 31c. During this time, the partitions 31a of the supplemental portion 26 may continue to be used as normal, and reading of the portion 31b of the main portion 24 may continue in a manner similar to that described above with respect to FIGS. 4a through 4c.

The greater size of the partitioned temporary files 154, means both that the number of merges required to fully assimilate the bulk index data 150 into the partitions 31b is reduced and the proportion of new data represented by the partitioned temporary files 154 with respect to the partition 31b of the main portion 24 is substantially greater thus improving the efficiency of the bulk-loading process by as much as an order of magnitude.

When the merging process is complete, the memory in the supplemental portion 26 taken up by partitioned temporary files 154 is free and the next partitioned temporary files 154 may be loaded. The updating does not interfere with normal processing as has been described and no special index reorganization is needed because the pre-partitioning preserves the indexing structure already in place. As a result, the bulk-loading may be accomplished on-line with only minor disruption to the use of the system 10 as is dictated by the speed of the merging process.

While the present invention has been described in the context of updating a document index, it will be understood to those of ordinary skill in the art that the same on-line updating technique can be applied generally to any electronic document that must be updated while in use by those reading the document. All that is required is that the updates be identifiable to a partition as may be done by hashing all or part of the update or by otherwise indexing the update portions to indicate a particular partition for which they are intended.

It is specifically intended that the present invention not be limited to the embodiments and illustrations contained herein, but that modified forms of those embodiments including portions of the embodiments and combinations of elements of different embodiments also be included as come within the scope of the following claims.

We claim:

1. A method of updating an electronic document for information retrieval comprising the steps of:
(a) dividing the electronic document into a plurality of partitions;
(b) receiving for the electronic document, update portions;
(c) matching the update portions to at least one partition;
(d) concurrently locking at least one partition for updating while keeping at least one partition unlocked for reading;
(e) updating the locked partition with the update portions only if the keyword matches with the locked partition; and
(f) changing the locked and unlocked partitions and repeating steps (d) and (e) to update each of the partitions over a predetermined period;
whereby the electronic document may be updated concurrently with use of the electronic document.

2. The method of claim 1 wherein the electronic document is an index linking a set of keywords to document identifiers, and the update portions are keywords and document identifiers for a new document and wherein at step (c) it is the keyword that is matched to a partition.

3. The method of claim 2 further including the steps of:
(g) matching portions of received queries to at least one partition;
(h) reading partitions matched to the portions to respond to the query.

4. The method of claim 3 wherein the matching of the portions of the queries to at least one partition of step (f) and the matching of the keywords for the new document to at least one partition of step (c) use a common mapping means.

5. The method of claim 4 wherein the mapping means is a hash table accepting the keyword as an argument to produce a partition as a value.

6. The method of claim 2 further including the step of storing the keywords and document identifiers for a new document in a change-log file before step (e) of updating the locked partition with the keyword and document identifiers for the new document.

7. The method of claim 5 wherein the change-log file includes a time stamp indicating the time of storing the keywords and document identifiers for a new document and the partitions include a time stamp indicating when the partition was last updated and wherein the step of updating the partition reads entries of the change-log file having a time stamp later than the time stamp of the partition and then updates the time stamp of the partition;
whereby updates are ensured to have been recorded in the change-log file.

8. The method of claim 2 wherein the partitions include an main portion stored in a first storage device having a first access speed and a supplemental portion stored in a second storage device having a second access speed faster than the first access speed, and wherein step (e) updates the supplemental portion of the locked partition, and further including the steps of:
(g) causing queries of the index to read both the index portion and the supplemental portion; and
(h) at predetermined intervals, merging the main portion with the supplemental portion.

9. The method of claim 8 predetermined period of time at which partitions are updated with the keywords and documents for the new document is less than the periodic interval when the main portion of the partition is updated with the supplemental portion of the partition.

10. The method of claim 8 wherein the main portions larger than the supplemental portion.

11. The method of claim 8 wherein the first storage device is a disk drive and the second storage device is solid-state memory.

12. The method of claim 8 wherein the predetermined interval is selected from the group consisting of: a periodic interval based on the amount of data stored in the supplemental portion, a constant periodic interval, and a periodic interval based on the partition.

13. The method of claim 8 wherein the merging of step (h) compacts the combined supplemental portion and main portion.

14. The method of claim 8 wherein the merging of step (h) computes global statistics of the combined supplemental portion and main portion.

15. The method of claim 8 wherein the merging of step (h) includes the steps of:
(i) freezing the supplemental portion and designating a second supplemental portion for receiving new keywords and document identifiers for new documents;
(ii) combining the frozen supplemental portion and the main portion to create a second main portion; and
(iii) deleting the frozen supplemental portion and the main portion and using the second supplemental portion as the supplemental portion and using the second main portion as the main portion.

16. The method of claim 14 wherein during step (i) queries are directed to the frozen supplemental portion, the second supplemental portion and the main portion.

17. The method of claim 14 wherein the supplemental portion and the main portions are identified by pointers and wherein step (iii) of using the second supplemental portion as the supplemental portion and using the second main portion as the main portion is accomplished by redirecting pointers.

18. The method of claim 8 further including the step of storing the keywords and document identifiers for a new document in a change-log file before step (e) of updating the locked partition with the keyword and document identifiers for the new document.

19. The method of claim 18 wherein the change-log file includes a time stamp indicating the time of storing the keywords and document identifiers for a new document and the partitions portion include a time stamp indicating when the partition portion was last updated and wherein the step of updating the partition portion updates the time stamp of the partition portion;
whereby loss of the supplemental portion may be remedied by reference to the change-log file.

20. The method of claim 18 wherein the step (e) of updating the locked partition with the keyword and document identifiers includes the step of reviewing each partition for the earliest time stamp and deleting from the change-log file all keywords having an earlier timestamp than the earliest time stamp for all partitions.

21. A method of updating an electronic document for information retrieval, the electronic document including a main portion stored in a first storage device having a given access speed, the method comprising the steps of:
(a) providing a supplemental portion in a second storage device having an access speed faster than the first storage device;
(b) storing, updates of the electronic document in the supplemental portion;
(c) causing queries of the electronic document to read both the supplemental portion and the main portion; and
(d) at predetermined intervals, merging the main portion with the supplemental portion;
whereby the electronic document may be updated concurrently with use.

22. The method of claim 21 wherein the electronic document is an index linking keywords to document identifiers and the update portion is linked keywords and document identifiers for a new document.

23. The method of claim 22 wherein the main portion is larger than the supplemental portion.

24. The method of claim 22 wherein the first storage device is a disk drive and the second storage device is solid-state memory.

25. The method of claim 22 wherein the predetermined interval is selected from the group consisting of: a periodic interval based on the amount of data stored in the supplemental portion and a constant periodic interval.

26. The method of claim 22 wherein the merging of step (d) compacts the combined supplemental portion and main portion.

27. The method of claim 22 wherein the merging of step (d) computes global statistics of the combined supplemental portion and main portion.

28. The method of claim 22 wherein the merging of step (d) includes the steps of:
(i) freezing the supplemental portion and designating a second supplemental portion for receiving new keywords and document identifiers for new documents;
(ii) combining the frozen supplemental portion and the main portion to create a second main portion;
(iii) deleting the frozen supplemental portion and the main portion and using the second supplemental portion as the supplemental portion and using the second main portion as the main portion.

29. The method of claim 28 wherein during step (i) queries are directed to the frozen supplemental portion, the second supplemental portion and the main portion.

30. The method of claim 28 wherein the supplemental portion and the main portions are identified by pointers and wherein step (iii) of using the second supplemental portion as the supplemental portion and using the second main portion as the main portion is accomplished by redirecting pointers.

31. The method of claim 22 further including the step of storing the keywords and document identifiers for a new document in a change-log file before step (d) of updating the main portion with the supplemental portion.

32. The method of claim 31 wherein the change-log file includes a time stamp indicating the time of storing the keywords and document identifiers for a new document and the main portion include a time stamp indicating when the main portion was last updated and wherein the step of updating the main portion updates the time stamp of the main portion;
whereby loss of the supplemental portion may be remedied by reference to the change-log file.

33. The method of claim 31 wherein the step (d) of updating the main portion includes the step of deleting from the change-log file all keywords having an earlier timestamp than that of the main portion.

34. The method of claim 22 including the further steps of:
dividing the main and supplemental portions of the index into a plurality of partitions;
at step (b) storing keywords and document identifiers for the new document a predetermined partition of the supplemental portion;
at the predetermined intervals, sequentially merging the partitions of the supplemental portion with corresponding partitions of the main portion;
receiving bulk-load keywords and document identifiers for the index;
pre-dividing the bulk-load keywords and document identifiers into partitioned files related to the partitions of the main and supplemental portions of the index;
sequentially storing a partitioned file in the second storage device and merging the partition file with the corresponding partition of the main portion;
whereby bulk-load data may be efficiently integrated with the index.

35. The method of claim 22 wherein the partition file is merged with the corresponding partition of the main portion at a second predetermined interval different from the first predetermined interval.

36. A system for information retrieval comprising:
an electronically readable document divided into a plurality of partitions;
a program executed on an electronic computer and communicating with the electronically readable document to:
(a) receiving update portions;
(b) matching the update portions to at least one partition;
(c) concurrently lock at least one partition for updating while keeping at least one partition unlocked for reading;
(d) update the locked partition with the keyword and document identifiers for the new document only if the keyword matches with the locked partition; and
(e) change the locked and unlocked partitions and repeat steps (d) and (e) to update each of the partitions over a predetermined period;
whereby the electronic document may be updated concurrently with use of the index.

37. The system of claim 36 wherein the electronic document is an index linking a set of keywords to document identifiers, and the update portions are keywords and document identifiers for a new document and wherein the program matches an update portion to a partition through the keyword.

38. The system of claim 37 wherein the program further executes the steps of:
(f) matching portions of the received queries to at least one partition;
(g) reading partitions matched to the portions to respond to the query.

39. The system of claim 38 wherein the matching of the portions of the queries to at least one partition of step (f) and the matching of matching of the keywords for the new document to at least one partition of step (c) use a common mapping means.

40. The system of claim 39 wherein the mapping means is a hash table accepting the keyword as an argument to produce a partition as a value.

41. The system of claim 37 further wherein the program further executes the step of storing the keywords and document identifiers for a new document in a change-log file before step (e) of updating the locked partition with the keyword and document identifiers for the new document.

42. The system of claim 41 wherein the change-log file includes a time stamp indicating the time of storing the keywords and document identifiers for a new document and the partitions include a time stamp indicating when the partition was last updated and wherein the step of updating the partition reads entries of the change-log file having a time stamp later than the time stamp of the partition and then updates the time stamp of the partition;
whereby updates are ensured to have been recorded in the change-log file.

43. The system of claim 37 wherein the partitions include an main portion stored in a first storage device having a first access speed and a supplemental portion stored in a second storage device having a second access speed faster than the first access speed, and wherein the program executes step (e) to updates the supplemental portion of the locked partition, and further including the steps of:
(g) causing queries of the index to read both the index portion and the supplemental portion; and
(f) at predetermined intervals, merging the main portion with the supplemental portion.

44. The system of claim 43 predetermined period of time at which partitions are updated with the keywords and documents for the new document is less than the periodic interval when the main portion of the partition is updated with the supplemental portion of the partition.

45. The system of claim 43 wherein the main portions larger than the supplemental portion.

46. The system of claim 43 wherein the first storage device is a disk drive and the second storage device is solid-state memory.

47. The system of claim 43 wherein the predetermined interval is selected from the group consisting of: a periodic interval based on the amount of data stored in the supplemental portion, a constant periodic interval, and a periodic interval based on the partition.

48. The system of claim 43 wherein the merging of step (f) compacts the combined supplemental portion and main portion.

49. The system of claim 43 wherein the merging of step (f) computes global statistics of the combined supplemental portion and main portion.

50. The system of claim 43 wherein the merging of step (f) includes the steps of:
(i) freezing the supplemental portion and designating a second supplemental portion for receiving new keywords and document identifiers for new documents;
(ii) combining the frozen supplemental portion and the main portion to create a second main portion; and
(iii) deleting the frozen supplemental portion and the main portion and using the second supplemental portion as the supplemental portion and using the second main portion as the main portion.

51. The system of claim 50 wherein during step (i) queries are directed to the frozen supplemental portion, the second supplemental portion and the main portion.

52. The system of claim 50 wherein the supplemental portion and the main portions are identified by pointers and wherein step (iii) of using the second supplemental portion as the supplemental portion and using the second main portion as the main portion is accomplished by redirecting pointers.

53. The system of claim 43 further wherein the program further executes the step of storing the keywords and document identifiers for a new document in a change-log file before step (e) of updating the locked partition with the keyword and document identifiers for the new document.

54. The system of claim 53 wherein the change-log file includes a time stamp indicating the time of storing the keywords and document identifiers for a new document and the partitions portion include a time stamp indicating when the partition portion was last updated and wherein the step of updating the partition portion updates the time stamp of the partition portion;
whereby loss of the supplemental portion may be remedied by reference to the change-log file.

55. The system of claim 53 wherein the step (e) of updating the locked partition with the keyword and document identifiers includes the step of reviewing each partition for the earliest time stamp and deleting from the change-log file all keywords having an earlier timestamp than the earliest time stamp for all partitions.

56. An system allowing on-line updating and comprising:
an electronically readable document including a main portion stored in a first storage device having a given access speed and a supplemental portion in a second storage device having an access speed faster than the first storage device;
an electronic computer communicating with the electronically readable document and executing a stored program to:
(a) store update portions in the supplemental portion;
(b) cause queries of the electronic document to read both the main portion and the supplemental portion; and
(c) at predetermined intervals, merging the main portion with the supplemental portion;
whereby the electronic document may be updated concurrently with use.

57. The system of claim 56 wherein the electronic document is an index linking a set of keywords to document identifiers, and the update portions are keywords and document identifiers for a new document.

58. The system of claim 57 wherein the main portion is larger than the supplemental portion.

59. The system of claim 57 wherein the first storage device is a disk drive and the second storage device is solid-state memory.

60. The system of claim 57 wherein the predetermined interval is selected from the group consisting of: a periodic interval based on the amount of data stored in the supplemental portion and a constant periodic interval.

61. The system of claim 57 wherein the merging of step (c) compacts the combined supplemental portion and main portion.

62. The system of claim 57 wherein the merging of step (c) computes global statistics of the combined supplemental portion and main portion.

63. The system of claim 57 wherein the merging of step (c) includes the steps of:
(i) freezing the supplemental portion and designating a second supplemental portion for receiving new keywords and document identifiers for new documents;
(ii) combining the frozen supplemental portion and the main portion to create a second main portion;
(iii) deleting the frozen supplemental portion and the main portion and using the second supplemental portion as the supplemental portion and using the second main portion as the main portion.

64. The system of claim 63 wherein during step (i) queries are directed to the frozen supplemental portion, the second supplemental portion and the main portion.

65. The system of claim 63 wherein the supplemental portion and the main portions are identified by pointers and wherein step (iii) of using the second supplemental portion as the supplemental portion and using the second main portion as the main portion is accomplished by redirecting pointers.

66. The system of claim 57 further wherein the program further executes the step of storing the keywords and document identifiers for a new document in a change-log file before step (d) of updating the main portion with the supplemental portion.

68. The system of claim 66 wherein the change-log file includes a time stamp indicating the time of storing the keywords and document identifiers for a new document and the main portion include a time stamp indicating when the main portion was last updated and wherein the step of updating the main portion updates the time stamp of the main portion;
whereby loss of the supplemental portion may be remedied by reference to the change-log file.

68. The system of claim 66 wherein the step (c) of merging the main portion and supplemental portions includes the step of deleting from the change-log file all keywords having an earlier timestamp than that of the main portion.

69. The system of claim 57 including the further steps of:
dividing the main and supplemental portions of the index into a plurality of partitions;
at step (b) storing keywords and document identifiers for the new document a predetermined partition of the supplemental portion;
at the predetermined intervals, sequentially merging the partitions of the supplemental portion with corresponding partitions of the main portion;
receiving bulk-load keywords and document identifiers for the index;
pre-dividing the bulk-load keywords and document identifiers into partitioned files related to the partitions of the main and supplemental portions of the index;
sequentially storing a partitioned file in the second storage device and merging the partition file with the corresponding partition of the main portion;
whereby bulk-load data may be efficiently integrated with the index.

70. The system of claim 57 wherein the partition file is merged with the corresponding partition of the main portion at a second predetermined interval different from the first predetermined interval.
